(19) United States
(12) Patent Application Publication
(10) Pub. No.: US 2024/0152839 A1
(43) Pub. Date: May 9, 2024

(54) MANAGEMENT APPARATUS, MANAGEMENT SYSTEM, TERMINAL DEVICE, AND NON-TRANSITORY COMPUTER-READABLE STORAGE MEDIUM STORING MANAGEMENT PROGRAM FOR MANAGING WORK ON LAVATORY EQUIPMENT

(71) Applicant: LIXIL Corporation, Tokyo (JP)

(72) Inventors: Shoji Ogawa, Tokyo (JP); Hiroki Shigetomo, Tokyo (JP); Toshiki Hashida, Tokyo (JP)

(73) Assignee: LIXIL Corporation, Tokyo (JP)

(21) Appl. No.: 18/502,690

(22) Filed: Nov. 6, 2023

(30) Foreign Application Priority Data
Nov. 9, 2022 (JP) 2022-179314

(51) Int. Cl. G06Q 10/0631

(52) U.S. Cl. CPC G06Q 10/06316

(57) ABSTRACT

In a management apparatus, an information acquirer acquires information from at least one of lavatory equipment and a sensor installed in a lavatory space. A work necessity determination unit determines, based on the acquired information, the lavatory equipment that requires work including cleaning and at least one of replenishment of a consumable and removal of an abnormality. A priority calculator calculates a priority of the work for the lavatory equipment determined to require the work based on the acquired information. An output unit outputs the calculated priority.

### CROSS-REFERENCE TO RELATED APPLICATION

This application claims priority to Japanese Patent Application No. 2022-179314 filed on Nov. 9, 2022, the entire contents of which is incorporated by reference.

### FIELD

The present disclosure relates to a management apparatus, a management system, a terminal device, and a non-transitory computer-readable storage medium storing a management program for managing work on lavatory equipment.

### BACKGROUND

Lavatories are essential installations both in houses where people live and in facilities used by people. Since the lavatory is an installation which tends to generate dirt and odors, it is important to maintain and manage the lavatory clean in order to make the house or facility a comfortable space. In particular, lavatories installed in commercial facilities, entertainment facilities, complex facilities, passenger station facilities, and the like used by large numbers of people need to be appropriately maintained and managed also from a viewpoint of public health.

A cleaning company entrusted with cleaning of lavatories by a manager of a facility patrols and cleans all lavatories several times a day according to a determined manual. In the case of a large-scale facility, the number of lavatories is several hundred, but it takes the time and effort of tens of persons in charge to clean all the lavatories.

Examples of the Related Art Include Japanese Unexamined Patent Application

### SUMMARY

As described above, in the present situation, the work for maintaining and managing lavatories installed in the facility relies on a human-wave strategy by a large number of persons in charge of the work, and requires a large amount of labor and cost. Improvement of work efficiency for lavatory equipment is required.

Considering such an issue, an object of the present disclosure is to provide a technique for appropriately managing work on lavatory equipment.

In order to solve the above issues, according to the present disclosure, a management apparatus includes an information acquirer that acquires information from at least one of lavatory equipment and a sensor installed in a lavatory space, a work necessity determination unit that determines, based on the acquired information, the lavatory equipment that requires work including cleaning and at least one of replenishment of a consumable and removal of an abnormality, a priority calculator that calculates a priority of the work for the lavatory equipment determined to require the work based on the acquired information, and an output unit that outputs the calculated priority.

According to some embodiments of the present disclosure, a management system includes a terminal device that is used by a person in charge of work on lavatory equipment installed in a lavatory space, and a management apparatus that manages the work on the lavatory equipment. The management apparatus includes an information acquirer that acquires information from at least one of the lavatory equipment and a sensor installed in the lavatory space, a work necessity determination unit that determines, based on the acquired information, the lavatory equipment that requires work including cleaning and at least one of replenishment of a consumable and removal of an abnormality, a priority calculator that calculates a priority of the work on the lavatory equipment determined to require the work based on the acquired information, a generator that generates display information for displaying a set of the lavatory equipment determined to require the work and the priority based on the calculated priority, and an output unit that outputs the generated display information to the terminal device. The terminal device includes a presenter that presents the display information output from the management apparatus, to the person in charge.

According to some embodiments of the present disclosure, a terminal device includes a presenter that presents, to a person in charge of work, a priority output from a management apparatus that calculates the priority of work on lavatory equipment determined to require the work including cleaning and at least one of replenishment of a consumable and removal of an abnormality, based on information acquired from at least one of the lavatory equipment and a sensor installed in a lavatory space.

Any combinations of the above components and modifications of the expressions of the present disclosure in methods, apparatuses, systems, recording media, computer programs, and the like are also effective as aspects of the present disclosure.

### BRIEF DESCRIPTION OF THE DRAWINGS

Embodiments will now be described, by way of example only, with reference to the accompanying drawings which are meant to be exemplary, not limiting, and wherein like elements are numbered alike in several FIGURES, in which:

FIG. 1 is a diagram illustrating a configuration of a management system according to some embodiments;

FIG. 2 is a functional block diagram illustrating a configuration of a management apparatus according to some embodiments;

FIG. 3 is a functional block diagram illustrating a configuration of a person-in-charge terminal according to some embodiments;

FIG. 4 is a sequence diagram illustrating processing of the management system according to some embodiments;

FIG. 5 is a diagram illustrating an example of a display screen displayed by the person-in-charge terminal, according to some embodiments;

FIG. 6 is a diagram illustrating another example of the display screen displayed by the person-in-charge terminal, according to some embodiments;

FIG. 7 is a diagram illustrating an example of a display screen displayed by the person-in-charge terminal, according to some embodiments;

FIG. 8 is a functional block diagram illustrating a configuration of a management apparatus according to some embodiments;

FIG. 9 is a sequence diagram illustrating processing of a management system according to some embodiments; and

FIG. 10 is a diagram illustrating an example of a display screen displayed by the person-in-charge terminal, according to some embodiments.

### DETAILED DESCRIPTION

In some embodiments of the present disclosure, a technique for managing work on lavatory equipment will be described. In a management system in the present embodiment, a person in charge of work on lavatory equipment works on only the lavatory equipment determined to require work such as cleaning by a management apparatus, instead of regularly patrolling all pieces of the lavatory equipment. As a result, it is possible to eliminate waste of working on unused lavatory equipment many times every day and to appropriately work on the lavatory equipment according to a use frequency or the like, so that it is possible to greatly improve work efficiency for lavatory equipment.

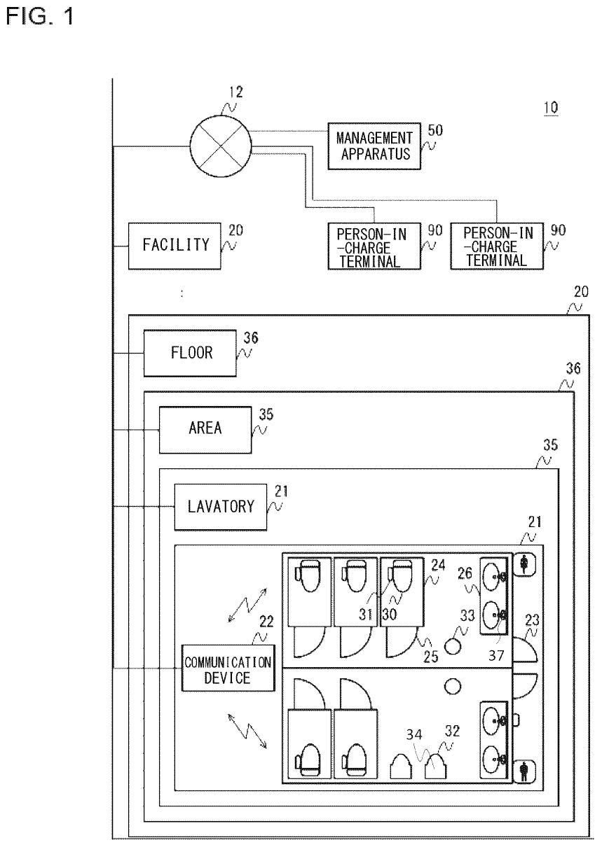

FIG. 1 illustrates a configuration of a management system according to some embodiments. A management system 10 includes a management apparatus 50 that manages work of lavatory equipment 40 installed in a lavatory 21 of a facility 20, a communication device 22 that transmits information from at least one of the lavatory equipment 40 and a sensor 33 installed in the lavatory 21 to the management apparatus 50, a person-in-charge terminal 90 of a person in charge of work on the lavatory equipment 40, and the Internet 12 as an example of communication means for communicating between these devices. The lavatory 21 in the present embodiment is an example of a lavatory space. The person-in-charge terminal 90 in the present embodiment is an example of an external terminal device.

The facility 20 is hierarchically managed in a plurality of hierarchies. The facility 20 has one or more floors 36, and the floor 36 has one or more areas 35. One or more lavatories 21 are provided in each area 35. The lavatory 21 is provided with the sensor 33, a door 23 of the lavatory 21, one or more private rooms 24, a door 25 of each private room 24, and the lavatory equipment 40 having a water receiver (not illustrated) that receives water discharged from a water discharger. The lavatory equipment 40 in the present embodiment includes a washbasin 26, a toilet 30 installed in each private room 24, and a urinal 32 installed in a male lavatory 21. The washbasin 26 includes a water faucet and a water receiver that receives water discharged from the water faucet, and includes, as necessary, a liquid soap supply device that supplies a liquid soap, a disinfectant supply device that supplies a disinfectant, and the like (neither is illustrated). In the private room 24 provided with the toilet 30, toilet paper is provided, and a lavatory seat cleaner supply device, a trash box, and the like are provided as necessary. The toilet 30 may be a Japanese toilet or a Western toilet. The lavatory equipment 40 includes controllers 31, 34, and 37 for a user of the lavatory equipment 40 to input an operation instruction to the lavatory equipment 40. Each of the controllers 31, 34, and 37 is configured to be able to transmit operation information indicating that the lavatory equipment 40 has operated, to the management apparatus 50 via the communication device 22 in response to the operation instruction input by a user. The sensor 33 is configured to be able to transmit detection information to the management apparatus 50 via the communication device 22.

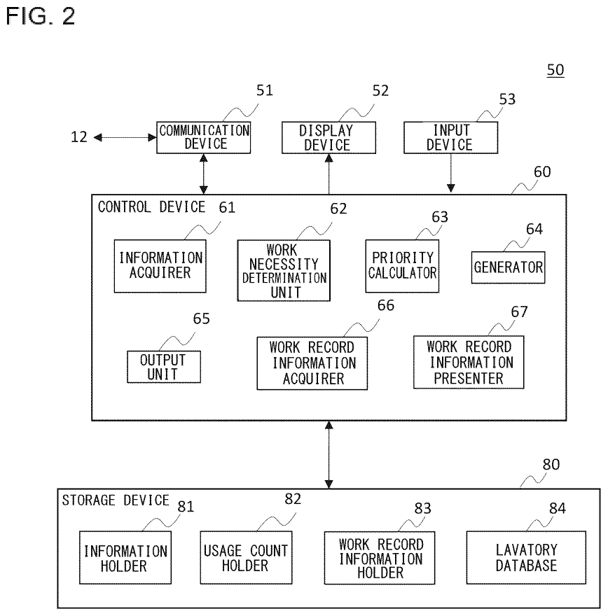

FIG. 2 is a functional block diagram illustrating a configuration of the management apparatus 50 according to some embodiments. The management apparatus 50 includes a communication device 51, a display device 52, an input device 53, a storage device 80, and a control device 60. The management apparatus 50 may be a server device, a device such as a personal computer, or a portable terminal such as a portable phone terminal, a smartphone, or a tablet terminal.

The communication device 51 controls communication with other devices. The communication device 51 may communicate by any wired or wireless communication scheme. The communication device 51 communicates with the communication device 22 via the Internet 12 and receives information from at least one of the lavatory equipment 40 and the sensor 33. The communication device 51 also communicates with the person-in-charge terminal 90 via the Internet 12.

The display device 52 displays a screen generated by the control device 60. The display device 52 may be a liquid crystal display device, an organic EL display device, or the like. The input device 53 transmits an instruction input by a user of the management apparatus 50 to the control device 60. The input device 53 may be a mouse, a keyboard, a touch pad, or the like. The display device 52 and the input device 53 may be mounted as a touch panel.

The storage device 80 stores programs, data, and the like used by the control device 60. The storage device 80 may be a semiconductor memory, a hard disk, or the like. The storage device 80 includes an information holder 81, a use count holder 82, a work record information holder 83, and a lavatory database 84.

The information holder 81 holds information acquired from at least one of the lavatory equipment 40 and the sensor 33. The use count holder 82 holds the number of times of using the lavatory equipment 40 as a work target. The work record information holder 83 holds information indicating a work record of the lavatory equipment 40 as the work target. The lavatory database 84 holds information regarding the lavatory equipment 40 as the work target. The lavatory database 84 holds, for example, information such as the number, positions, floors, and plan views of the lavatories 21, the number and positions of the private rooms installed in the lavatory 21, and the installation location, the installation floor, the number of installations, the type, the elapsed time from the installation, the use frequency, the work frequency, the manufacturing date, the manufacturing number, and the like of pieces of the lavatory equipment 40.

The control device 60 includes an information acquirer 61, a work necessity determination unit 62, a priority calculator 63, a generator 64, an output unit 65, a work record information acquirer 66, and a work record information presenter 67. These components are realized by a CPU, a memory, another LSI, or the like of any computer in terms of hardware, and are realized by a program loaded in the memory or the like in terms of software. Here, functional blocks realized by cooperation of the hardware and the software are illustrated. Therefore, it is understood by those skilled in the art that these functional blocks can be realized in various forms such as only hardware or a combination of hardware and software.

The information acquirer 61 acquires information from at least one of the lavatory equipment 40 and the sensor 33 via the communication device 22 and stores the information in the information holder 81.

The work necessity determination unit 62 calculates the number of times of use of the lavatory equipment 40 based on the information acquired by the information acquirer 61, and updates the number of times of use stored in the use count holder 82. The work necessity determination unit 62 in the present embodiment determines the lavatory equipment 40 that requires work based on the number of times of use stored in the use count holder 82.

The priority calculator 63 calculates the priority of work on the lavatory equipment 40 determined to require work based on the information acquired by the information acquirer 61. A method of calculating the priority will be described later.

The generator 64 generates priority information for displaying a set of the lavatory equipment 40 determined to require work and the priority thereof based on the calculated priority. The priority information in the present embodiment is an example of display information.

The output unit 65 outputs the calculated priority. The output unit 65 in the present embodiment outputs the priority by outputting the priority information to the person-in-charge terminal 90. The output unit 65 in the present embodiment outputs a work instruction including the priority information to the person-in-charge terminal 90.

The work record information acquirer 66 acquires work record information from the person-in-charge terminal 90 and stores the work record information in the work record information holder 83.

The work record information presenter 67 reads the work record information held in the work record information holder 83 and presents the work record information to a manager of the facility 20, a manager of the work, another person in charge of the work, and the like.

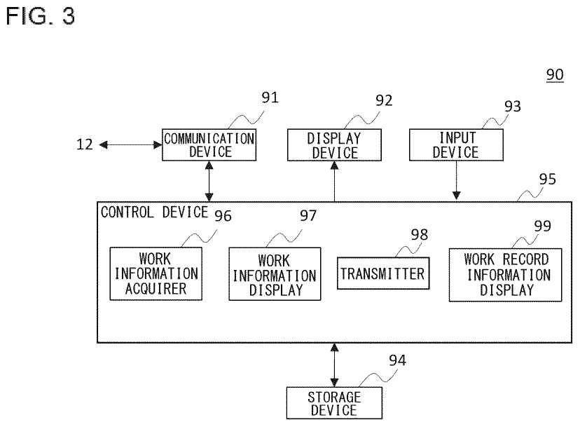

FIG. 3 is a functional block diagram illustrating a configuration of the person-in-charge terminal 90 according to some embodiments. The person-in-charge terminal 90 includes a communication device 91, a display device 92, an input device 93, a storage device 94, and a control device 95. The person-in-charge terminal 90 may be a device such as a personal computer, or may be a portable terminal such as a portable phone terminal, a smartphone, or a tablet terminal.

The communication device 91 controls communication with other devices. The communication device 91 may communicate by any wired or wireless communication scheme. The communication device 91 communicates with the management apparatus 50 via the Internet 12.

The display device 92 displays a screen generated by the control device 95. The display device 92 may be a liquid crystal display device, an organic EL display device, or the like. The input device 93 transmits an instruction input by the person in charge of work to the control device 95. The input device 93 may be a mouse, a keyboard, a touch pad, or the like. The display device 92 and the input device 93 may be mounted as a touch panel. The storage device 94 stores programs, data, and the like used by the control device 95.

The control device 95 includes a work instruction acquirer 96, a work instruction display 97, a transmitter 98, and a work record information display 99. These components can also be realized in various forms such as only hardware or a combination of hardware and software.

The work instruction acquirer 96 acquires a work instruction from the management apparatus 50. The work instruction display 97 displays the work instruction acquired by the work instruction acquirer 96 on the display device 92. The work instruction display 97 in the present embodiment displays the priority of the work included in the work instruction on the display device 92.

When the person in charge of the work has completed the work, the transmitter 98 transmits work record information including a message that the work has been completed, the content of the work, and the like to the management apparatus 50.

The work record information display 99 acquires work record information by another person in charge of work from the management apparatus 50 and displays the acquired work record information on the display device 92.

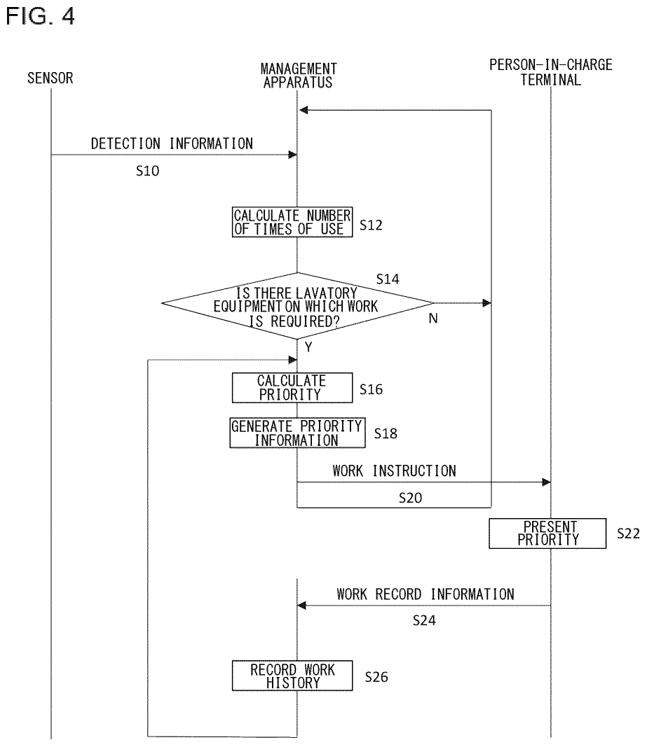

FIG. 4 is a sequence diagram illustrating processing of the management system 10 according to some embodiments.

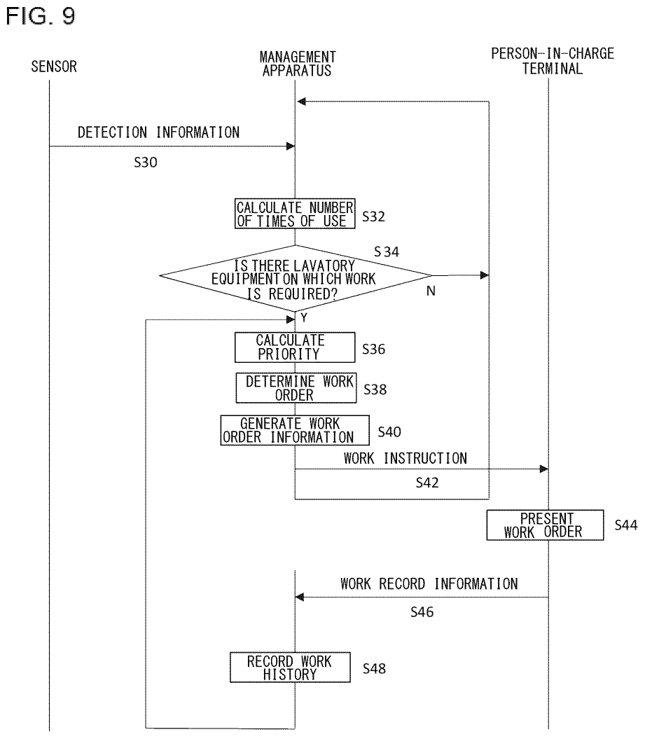

In Step S10, the information acquirer 61 acquires detection information from the sensor 33 via the communication device 22. The sensor 33 may be, for example, an opening/closing sensor of the door 25 of the private room 24, a sensor that detects locking/unlocking of a key installed in the door 25, a pyroelectric sensor, a human sensor, a temperature sensor, a seating sensor of the toilet 30, a drain sensor, a clogging sensor, an odor sensor, a dirt sensor, a sound sensor, or the like. In the example of FIG. 4, the management apparatus 50 acquires the detection information from the sensor 33, but may acquire operation information from the lavatory equipment 40. The same applies to FIG. 9 described later.

In Step S12, the work necessity determination unit 62 calculates the number of times of use of each piece of lavatory equipment 40 based on the acquired information. The work necessity determination unit 62 may calculate the number of times of use of the lavatory equipment 40, for example, from the number of times of opening and closing detected by the opening and closing sensor of the door 25 of the private room 24, the number of times of locking and unlocking detected by the sensor that detects locking and unlocking of the key installed in the door 25, the number of times of a user being detected by the pyroelectric sensor, the human sensor, the temperature sensor, or the like, the number of times of seating detected by the seating sensor of the toilet 30, the number of times of discharge detected by the drain sensor of the lavatory equipment 40, the time when the liquid soap is discharged by the liquid soap supply device of the washbasin 26, the number of times of discharge of water from the water faucet of the washbasin 26, the time when water is discharged from the water faucet, the operation information of each piece of lavatory equipment, and the like.

In Step S14, the work necessity determination unit 62 determines the lavatory equipment 40 that requires work. The work here includes cleaning work, replenishment work of a consumable, and removal work of an abnormality. The replenishment of a consumable here includes, for example, replenishment of toilet paper, replenishment of a disinfectant, replenishment of a liquid soap to a liquid soap supply device (not illustrated) such as an automatic soap provided in the washbasin 26, and the like. The abnormality here includes, for example, clogging of the water receiver of the lavatory equipment 40, a failure or abnormality of a shower lavatory device (for example, a buttock cleaning water nozzle, a bidet cleaning water nozzle, a drying device, a deodorizing device, and a heated lavatory seat) provided in the toilet 30, a failure or abnormality of a flush device (not illustrated) of the toilet 30 and the urinal 32, a failure or abnormality of the water faucet or the liquid soap supply device of the washbasin 26, and the like. For example, the work necessity determination unit 62 determines that cleaning work is required for the lavatory equipment 40 having the number of times of use that exceeds a threshold value. The management apparatus 50 may determine the lavatory equipment 40 that requires cleaning work based on the odor, dirt, and the like of the lavatory equipment 40. For example, when it is detected that dirty water overflows from the water receiver of the lavatory equipment 40, the work necessity determination unit 62 may determine that the work of removing an abnormality is required. The work necessity determination unit 62 may determine that replenishment work is required, for example, when the number of times of use exceeds the threshold value or when it is detected that toilet paper or a liquid soap in a liquid soap supply device (not illustrated) provided at the washbasin 26 has run out. When there is no lavatory equipment 40 determined to require work (N in Step S14), the process returns to Step S10. When there is the lavatory equipment 40 determined to require work (Yin Step S14), the process proceeds to Step S16.

In Step S16, the priority calculator 63 calculates the priority of work on the lavatory equipment 40 determined to require work based on the acquired information. For example, by using the determination result of the work based on the acquired information, the priority calculator 63 sets the work priority for the lavatory equipment 40 determined to require cleaning work to 1, sets the work priority for the lavatory equipment 40 determined to require replenishment work to 3, and sets the work priority for the lavatory equipment 40 determined to require abnormality removal work to 5. When it is determined that a plurality of pieces of work is required among the cleaning work, the replenishment work, and the abnormality removal work, the priority assigned to the work determined to be required is added. For example, when it is determined that the cleaning work with the priority of 1 and the replenishment work with the priority of 3 are required, the priority of the work on the lavatory equipment 40 is 1+3=4.

The priority of the lavatory equipment 40 determined to require at least one of replenishment of a consumable and removal of an abnormality is preferably higher than the priority of the lavatory equipment 40 determined to require cleaning work. In addition, the priority of the lavatory equipment 40 determined to require abnormality removal work is preferably higher than the priority of the lavatory equipment 40 determined to require consumable replenishment work.

In Step S18, the generator 64 generates priority information based on the calculated priority.

In Step S20, the output unit 65 outputs the work instruction of the lavatory equipment 40 determined to require work to the person-in-charge terminal 90. The work instruction in some embodiments includes the priority information for the lavatory equipment 40 determined to require work. For example, the output unit 65 may output the work instruction to the person in charge of work in units of the lavatory equipment 40 and the lavatory 21, or may output the work instruction in units of the content of work.

In Step S22, the work instruction display 97 of the person-in-charge terminal 90 presents the priority information in the work instruction output from the management apparatus 50 to the person in charge of work. An example of a display screen of the priority information in some embodiments will be described later.

When the person in charge of work completes the work of the lavatory equipment 40 and inputs a message that the work has been completed, to the person-in-charge terminal 90, in Step S24, the transmitter 98 of the person-in-charge terminal 90 transmits work record information including the message that the work has been completed, the content of the work, and the like to the management apparatus 50.

In Step S26, the work record information acquirer 66 acquires the work record information from the person-in-charge terminal 90, and stores the work record information in the work record information holder 83 as a work history of the lavatory equipment 40.

Thereafter, the process returns to Step S16, and the priority calculator 63 newly calculates the priority of the lavatory equipment 40 determined to require work. In Step S18, the generator 64 generates priority information based on the newly calculated priority. In Step S20, the output unit 65 outputs a work instruction including the latest priority information to the person-in-charge terminal 90. In Step S22, the work instruction display 97 of the person-in-charge terminal 90 presents the work instruction including the latest priority output from the management apparatus 50 to the person in charge of work. The person in charge of work moves to the installation location of the lavatory equipment 40 to be worked next, and works on the lavatory equipment 40.

When a plurality of pieces of lavatory equipment 40 installed in the facility 20 are worked by a plurality of persons in charge of work, the pieces of lavatory equipment 40 assigned to the respective persons in charge of work may be determined in advance so as not to overlap with each other.

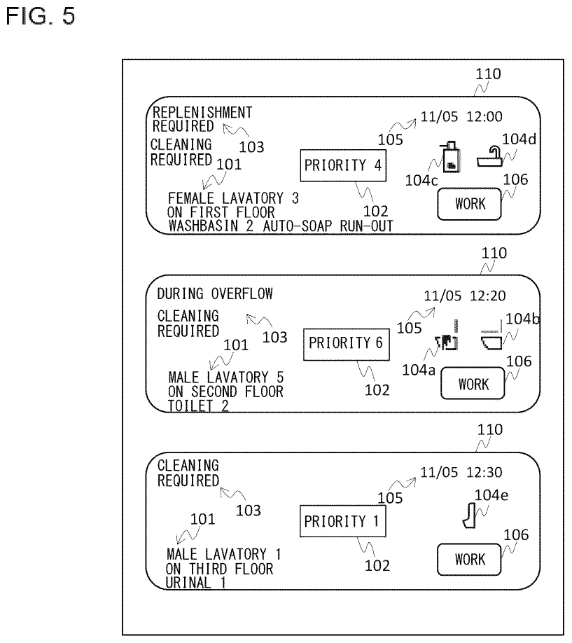

FIG. 5 illustrates an example of a display screen of the priority information displayed by the person-in-charge terminal 90 according to some embodiments. In the example of FIG. 5, work instructions for three pieces of lavatory equipment 40 determined to require work are illustrated in each work instruction region 110. Each work instruction region 110 includes a lavatory equipment identification region 101 for identifying the lavatory equipment 40 determined to require work, a priority display region 102 for displaying the priority, a work display region 103 for displaying the required work, an indicator 104 indicating the required work, a determination date and time display region 105 for displaying the date and time when the work is determined to be required, and a work completion button 106 for inputting a message that the work has been completed. Indicators 104a to 104e in FIG. 5 indicate that abnormality removal work is required due to overflow of the toilet 30, that cleaning work on the toilet 30 is required, that replenishment work of a liquid soap is required, that cleaning work of the washbasin 26 is required, and that cleaning work of the urinal 32 is required, respectively.

As described above, the latest priority is calculated and the person-in-charge terminal 90 is notified of the calculated priority each time the work on the lavatory equipment 40 is completed. Thus, the person-in-charge terminal 90 may display only the lavatory equipment 40 to be worked next on the display device 92. However, by displaying the lavatory equipment 40 to be worked next and thereafter on the display device 92, it is possible to indicate the prospect of the future work to the person in charge of work.

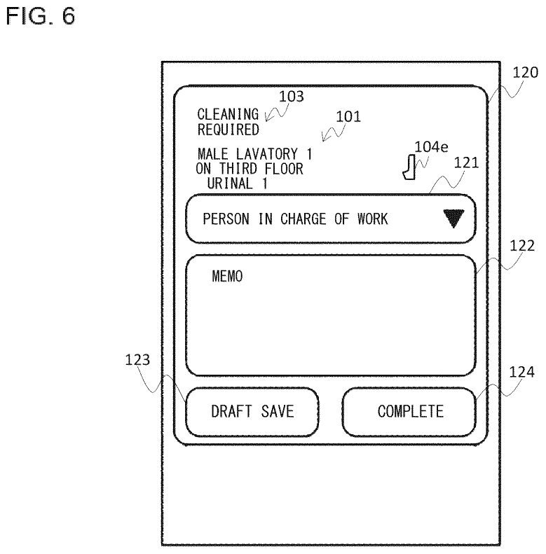

FIG. 6 illustrates another example of the display screen at the time of work completion, which is displayed by the person-in-charge terminal 90. When the person in charge of work completes the work on the lavatory equipment 40, the display screen shifts to a display screen 120 at the time of work completion in FIG. 6 by pressing the work completion button 106 in FIG. 5. The display screen 120 at the time of work completion in FIG. 6 includes a lavatory equipment identification region 101, a work display region 103, an indicator 104 (104e), a person-in-charge-of-work input region 121, a memo region 122, a draft save button 123, and a completion button 124. In the memo region 122, for example, the content of work, situations of the lavatory equipment 40 and the lavatory 21, presence or absence and the content of a trouble, information regarding a person in charge of work, and the like are input. After necessary items are input on the display screen at the time of work completion, the completion button 124 is pressed to complete the input indicating that the work has been completed, and each input item is transmitted to the management apparatus 50 as work record information.

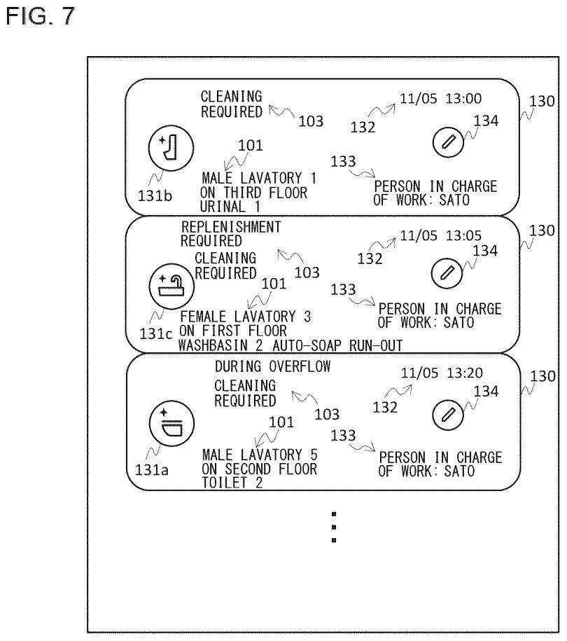

The work history and the information input by the person in charge of work may be able to be confirmed or corrected by the manager of the facility 20, the manager of work, another person in charge of work, or the like. FIG. 7 illustrates an example of a display screen of the work history displayed by the person-in-charge terminal 90. In the example of FIG. 7, the work history of the lavatory equipment 40 on which work has been completed is shown in each work history display region 130. Each work history display region 130 includes a lavatory equipment identification region 101, a work display region 103, an indicator 131 indicating that work has been completed, a work completion date and time display region 132, a person-in-charge-of-work display region 133, and a memo viewing button 134. The work history display regions 130 are arranged side by side from the top in order of completion of the work. Indicators 131a to 131c in FIG. 7 indicate that the work on the toilet 30 has been completed, that the work on the urinal 32 has been completed, and that the work on the washbasin 26 has been completed, respectively. By pressing the memo viewing button 134, it is possible to view the contents input in the memo region 122 of FIG. 6 at the time of work completion.

In some embodiments, the management apparatus 50 determines the lavatory equipment 40 that requires work including cleaning of lavatory equipment 40 and at least one of replenishment of a consumable for the lavatory equipment 40 and removal of an abnormality of the lavatory equipment 40, and calculates and outputs the priority of work on the lavatory equipment 40 determined to require work. According to some embodiments, it is possible to perform work in an appropriate order by referring to the priority, and thus, it is possible to further improve the work efficiency for the lavatory equipment 40.

In some embodiments, the management apparatus 50 generates the priority information for displaying a set of the lavatory equipment 40 determined to require work and the priority thereof based on the calculated priority, and outputs the priority by outputting the priority information to the person-in-charge terminal 90. According to some embodiments, the person in charge of work works on the lavatory equipment 40 based on the priority presented to the person-in-charge terminal 90, so that it is possible to efficiently advance the work on the lavatory equipment 40.

In some embodiments, the priority of the lavatory equipment determined to require at least one of replenishment of a consumable and removal of an abnormality is higher than the priority of the lavatory equipment determined to require cleaning work. According to some embodiments, the person in charge of work can appropriately work according to the urgency of work.

In some embodiments, the priority of the lavatory equipment 40 determined to require work of removing an abnormality is higher than the priority of the lavatory equipment 40 determined to require work of replenishing a consumable. According to some embodiments, the person in charge of work can appropriately work according to the urgency of work.

In the example of FIG. 5, a set of each piece of lavatory equipment 40 that requires work and the priority of the work thereof is displayed side by side from the top in the order of the earlier determination date and time, but some embodiments are not limited thereto. The display information may be configured to display the sets side by side in descending order of priority. The display information itself may have an image in which the sets are arranged in descending order of priority, or the display information may cause the person-in-charge terminal 90 to create an image in which the sets are arranged in descending order of priority based on the priority information. According to some embodiments, it is possible to easily recognize the lavatory equipment 40 having a high work priority. Thus, it is possible to efficiently advance the work on the lavatory equipment 40.

In some embodiments, an example of managing the lavatory equipment 40 installed in the lavatory 21 of the facility 20 has been described. The technique in the present disclosure is also applicable to a case of managing a lavatory of a general house, a public lavatory installed in a park, a road, or the like.

In some embodiments, the lavatory equipment 40 includes the washbasin 26, the toilet 30, and the urinal 32. However, some embodiments are not limited to this. For example, a waste flushing unit or the like having a bowl portion for an ostomate to treat waste such as excrement. The lavatory equipment 40 may be any equipment that is installed in the lavatory 21, includes a water receiver that receives water discharged from a water discharger, and may overflow the water when the water receiver is clogged.

In some embodiments, the work includes cleaning, replenishment of a consumable, and removal of an abnormality, but it is sufficient that the work includes cleaning and at least one of replenishment of a consumable and removal of an abnormality.

In some embodiments, by using the determination result of the work based on the acquired information, the priority is calculated according to which of the cleaning, the replenishment of a consumable, and the removal of an abnormality is the work. However, some embodiments are not limited thereto. The priority calculator may directly calculate the priority from the acquired information, for example, calculates the priority as 5 when it is detected that dirty water overflows from the water receiver of the lavatory equipment 40.

In some embodiments, the priority is calculated based on the comparison between the number of times of use of the lavatory equipment 40 calculated from the acquired information and the threshold value. The threshold value may be different in the washbasin 26, the toilet 30, and the urinal 32. In other words, the threshold value includes a threshold value for the toilet 30, a threshold value for the urinal 32, and a threshold value for the washbasin 26 which are different each other. According to some embodiments, it is possible to perform cleaning work and replenishment work at an appropriate timing for each of the washbasin 26, the toilet 30, and the urinal 32. The threshold value may be different depending on the type of the lavatory 21 (for example, a male lavatory, a female lavatory, a multi-purpose lavatory, and a child lavatory), the model of the lavatory equipment 40, and the like. Further, the threshold value may be automatically changed depending on the increase, decrease or congestion status of people in the facility 20, a floor 36, an area 35, and the lavatory 21, the time period, the weather around the facility 20, the number of claims received for the lavatory 21, the usage amounts or remaining amounts of toilet paper, liquid soap, disinfectant, the odor of the lavatory 21, and the like. Some embodiments are not limited to the comparison between the number of times of use of the lavatory equipment 40 and the threshold value. For example, the priority may be calculated based on a comparison between the use time of the lavatory equipment 40 and a threshold value. In summary, the priority may be calculated based on a comparison of a use degree indicating the degree of use of the lavatory equipment 40 to the threshold value.

In some embodiments, a different priority is calculated for each type of work such as cleaning work, replenishment work, and abnormality removal work. However, some embodiments are not limited thereto. Similarly to the threshold value, a different priority may be calculated according to the type (for example, the washbasin 26, the toilet 30, and the urinal 32) of the lavatory equipment 40, the type (for example, a male lavatory, a female lavatory, a multi-purpose lavatory, and a child lavatory) of the lavatory 21, the model of the lavatory equipment 40, the increase/decrease or congestion status of people in the facility 20, the floor 36, the area 35, and the lavatory 21, a time period, the weather around the facility 20, the number of claims received for the lavatory 21, the use amount or remaining amount of toilet paper, a liquid soap, or a disinfectant, the odor of the lavatory 21, and the like.

The priority may be calculated based on at least one of a movement distance, a movement time, presence or absence of floor movement, a number of floor movements, and means for floor movement when movement is performed from a current position of the person in charge to the lavatory equipment 40 determined to require the work, an elapsed time after the lavatory equipment 40 is determined to require the work, and a dirt degree, a number of times of use, and a use state of the lavatory equipment 40 determined to require the work. For example, the priority calculator 63 can acquire information indicating the current position from the person-in-charge terminal 90 by using a GPS, a beacon, or the like, or by reading the location of the lavatory equipment 40 on which work has been performed most recently by the person in charge of work from the work record information holder 83. For example, in a directed graph having the current position of the person in charge of work as a start point and each of the plurality of pieces of lavatory equipment 40 determined to require work as a vertex, the priority calculator 63 may calculate the priorities of a plurality of pieces of lavatory equipment 40 based on an optimum path obtained to minimize the total cost when a value calculated from at least one of a movement distance between vertices, a movement time, the presence or absence of floor movement, the number of floor movements, or means for floor movement, an elapsed time after the lavatory equipment 40 is determined to require work, a dirt degree of the lavatory equipment 40, the number of times of use of the lavatory equipment 40, and the use situation of the lavatory equipment 40 is used as the cost between vertices. The priority calculator 63 may convert each item into a required time to set the cost between vertices. For example, in a case where movement is performed between the floors when movement is performed between vertices, the priority calculator 63 may add the movement time according to the number of floor movements and the means for floor movement to the movement time calculated from the movement distance. When the toilet 30 as a work target is in use, the priority calculator 63 may add a waiting time until the toilet 30 can be cleaned, to the cost. In addition, the larger the dirt degree of the lavatory equipment 40, the longer the cleaning time is required. Thus, the priority calculator 63 may increase the cost. In addition, the longer the elapsed time from the determination that the lavatory equipment 40 requires work, the longer the state in which the lavatory equipment 40 is dirty. Therefore, the priority calculator 63 may reduce the cost in order to increase the cleaning order. Furthermore, the cost may be reduced in order to increase the work order as the dirt degree or the number of times of use of the lavatory equipment 40 increases. As the movement time between the vertices, an approximate value of the movement time between the regions to which the vertices belong may be used. For example, an approximate value of the movement time may be assigned according to a hierarchical relationship between vertices in a hierarchical region such as the facility 20, the area 35, the floor 36, and the lavatory 21. The hierarchical relationship may be calculated by comparing the hierarchical relationship with the degree of intimacy used as a measure representing the degree of intimacy/sparseness of the family relationship. The priority calculator 63 may calculate the cost by weighting each item. The priority calculator 63 may solve the optimum path problem by any algorithm such as the Bellman-Ford method. According to these configurations, since it is possible to calculate the priority in consideration of the efficiency of movement of the person in charge of work, it is possible to improve the work efficiency of the person in charge of work.

Upon receiving an input indicating that the work on specific lavatory equipment 40 is suspended among pieces of the lavatory equipment determined to require work from the person-in-charge terminal 90, the generator 64 may generate display information (priority information or work order information) in which a set related to the specific lavatory equipment 40 is deleted. For example, by swiping the work instruction region 110 in FIG. 5 or by providing a work suspension button in the work instruction region 110 and pressing the work suspension button, the generator 64 configures the display information to be able to transmit, to the management apparatus 50, a message that the work corresponding to the lavatory equipment 40 corresponding to the work instruction region 110 is suspended. Upon receiving that the work is suspended, the generator 64 re-generates display information in which the set of the lavatory equipment 40 and the priority or work order thereof is deleted. According to some embodiments, when the lavatory equipment 40 is in use and it is not possible for the person in charge of work to perform work, the person in charge of work can temporarily suspend the work and perform work later. In some embodiments, the generator may generate the display information to re-display the deleted set when a predetermined re-display condition is satisfied. The predetermined redisplay condition here is, for example, a case where a predetermined time has elapsed after the work is suspended, a case where a specific input for releasing the suspension of the work is received from the person-in-charge terminal 90, or the like. According to some embodiments, it is possible to suppress an occurrence of a situation in which the user forgets to perform work on the lavatory equipment on which the work has been suspended.

The priority calculator 63 may calculate the priority based on the necessity of work on an installation disposed outside the lavatory 21 in the facility 20. The work on the installation here is, for example, cleaning of a trash box and a floor, replenishment of a disinfectant, and the like. For example, when work is required for an installation outside the lavatory 21 around the lavatory equipment 40 determined to require work (the same area 35, the same floor 36, or the like), the priority calculator may increase the priority of the lavatory equipment 40. The necessity of work on the installation outside the lavatory 21 may be determined, for example, based on the time period when work on the installation is periodically performed, or may be determined based on detection that the trash box is full or that the disinfectant has run out.

In some embodiments, by pressing the work completion button 106 of FIG. 5 and the completion button 124 of FIG. 6, a message that the work has been completed is input to the management apparatus 50, but some embodiments are not limited thereto. When a predetermined work completion condition is satisfied, the generator 64 may generate the display information to automatically transmit a message that the work on the lavatory equipment 40 determined to require the work has been completed, to the management apparatus 50. For example, the work completion condition may include a case corresponding to a predetermined date and time condition such as a day of the week, a time, and a holiday. For example, when the work system of a worker is set to complete the work on all pieces of the lavatory equipment 40 until a specific time such as 30 minutes before opening of a store, a message that the work has been completed for all pieces of the lavatory equipment 40 before 30 minutes before the opening of the store by using the date and time condition that is 30 minutes before the opening of the store is transmitted to the management apparatus 50. As a result, it is possible to reduce time and effort to input that the work has been completed, by operating the screen of the person-in-charge terminal 90. The work completion condition may include, for example, a case where predetermined work (for example, replenishment of toilet paper, or a special operation of lavatory equipment 40) has been performed, a case where it is detected that dirt is equal to or smaller than a predetermined criterion, a case where the person-in-charge terminal 90 is at a predetermined position, a case where image data of the lavatory equipment 40 on which the work has been completed is transmitted to the management apparatus 50 by the person-in-charge terminal 90, a case where a specific action pattern of the worker is detected after the special operation of the lavatory equipment 40, and the like. According to some embodiments, it is also possible to reduce time and effort to input that the work has been completed, by operating the screen of the person-in-charge terminal 90. The display information itself may include a command for causing the person-in-charge terminal 90 to execute a process for automatically transmitting the message that the work has been completed. Alternatively, an application for automatically transmitting the message that the work has been completed may be installed on the person-in-charge terminal 90 in advance, and the person-in-charge terminal 90 may determine whether or not the work completion condition is satisfied in response to reception of the display information.

A notification device including an LED lamp and the like may be provided in the vicinity of the washbasin 26, the toilet 30, and the urinal 32, and a work instruction may be transmitted to the notification device to blink the LED lamp of the notification device. In this manner, a notification of a message that work on the lavatory equipment 40 is required may be performed. In this case, the notification device may be able to transmit the message that the work has been completed to the management apparatus 50 in a manner that the blinking of the LED lamp by the notification device turns off.

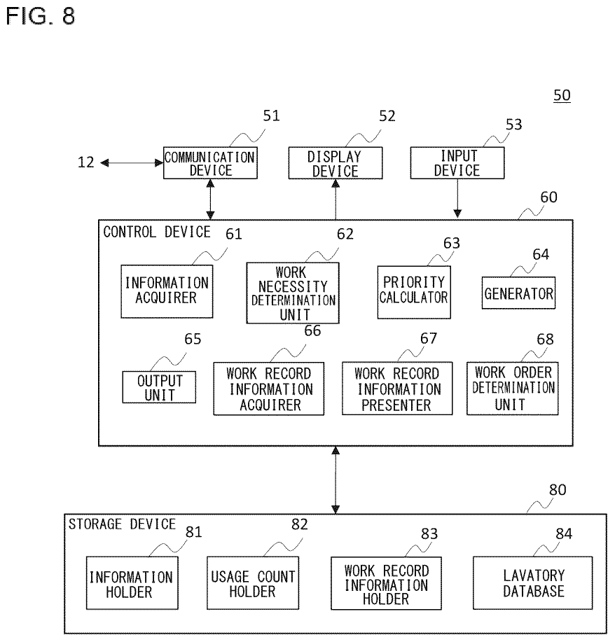

FIG. 8 is a functional block diagram illustrating a configuration of a management apparatus 50 according to some embodiments. The management apparatus in the second embodiment further includes a work order determination unit 68. The work order determination unit 68 determines the work order of the lavatory equipment 40 determined to require work by the work necessity determination unit 62 based on the priority of work. The generator 64 in some embodiments generates work order information for displaying a set of the lavatory equipment 40 determined to require work and the work order based on the determined work order. The work order information in some embodiments is an example of the display information. The output unit 65 in some embodiments outputs a work instruction including the work order information to the person-in-charge terminal 90.

FIG. 9 is a sequence diagram illustrating processing of a management system 10 according to some embodiments. Steps S30 to S36, S46, and S48 in FIG. 9 are basically similar to Steps S10 to S16, S24, and S26 in FIG. 4 except for the points particularly mentioned, and thus the description thereof will be omitted.

When the priority of work is calculated in Step S36, the output unit 65 outputs the priority calculated by the priority calculator 63 to the work order determination unit 68. In Step S38, the work order determination unit 68 determines the work order of the lavatory equipment 40 determined to require work by the work necessity determination unit 62 based on the priority output from the output unit 65. For example, the work order determination unit 68 orders the lavatory equipment 40 determined to require work in descending order of priority.

In Step S40, the generator generates the work order information based on the determined work order. In Step S42, the output unit outputs a work instruction including the work order information to the person-in-charge terminal 90. The work instruction may include the calculated priority in addition to the work order information. In Step S44, the work instruction display 97 of the person-in-charge terminal 90 presents the work instruction output from the management apparatus 50 to the person in charge of work.

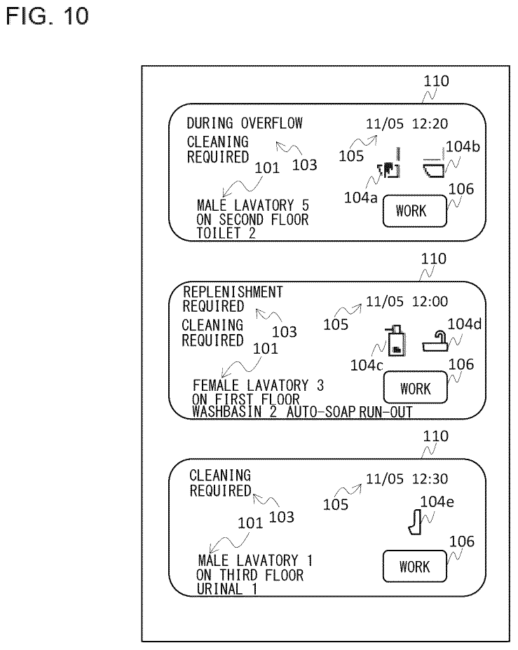

FIG. 10 illustrates an example of a display screen of the work order displayed by the person-in-charge terminal 90 according to some embodiments. In the example of FIG. 10, a set of each piece of lavatory equipment 40 that requires work and the priority of the work is illustrated by being arranged from the top in descending order of the priority. However, some embodiments are not limited to illustration of the set in the arrangement order, and the set may be illustrated by displaying the priority order (first, second, and the like) of the work. Furthermore, the work order of the lavatory equipment 40 that requires work may be displayed in a map format of the lavatory 21.

In some embodiments, the work order of the lavatory equipment 40 determined to require work is determined based on the work priority. According to some embodiments, it is possible to perform work in an appropriate order by referring to the work order, and thus, it is possible to further improve the work efficiency for the lavatory equipment 40.

In some embodiments, the work order determination unit 68 determines the work order of the lavatory equipment 40 determined to require work in descending order of priority, but some embodiments are not limited thereto. For example, the work order determination unit 68 may determine the work order based on the priority and at least one of the movement distance, the movement time, the presence or absence of floor movement, the number of floor movements, and the means for floor movement when movement is performed from the current position of the person in charge to the lavatory equipment 40 determined to require the work, the elapsed time after the lavatory equipment 40 is determined to require the work, and the dirt degree, the number of times of use, and the use state of the lavatory equipment 40 determined to require the work. According to some embodiments, it is possible to determine the work order in consideration of the efficiency of movement of the person in charge of work, the degree of necessity of work, and the like. Thus, it is possible to improve the work efficiency of the person in charge of work.

In some embodiments, the work order determination unit 68 determines the work order of the lavatory equipment 40 determined to require work by the work necessity determination unit 62 based on the priority output from the output unit 65, but some embodiments are not limited thereto. The work order determination unit 68 may determine the work order of the lavatory equipment 40 based on the information acquired by the information acquirer 61.

Although the present disclosure has been described above based on various embodiments, these embodiments merely illustrate the principle and application of the present disclosure. In addition, many modification examples and changes in arrangement in the embodiments can be made in a range without departing from the spirit of the present disclosure defined in the claims.

1. A management apparatus comprising:
an information acquirer that acquires information from at least one of a lavatory equipment and a sensor installed in a lavatory space;
a work necessity determination unit that determines, based on the acquired information, the lavatory equipment that requires work including cleaning and at least one of replenishment of a consumable and removal of an abnormality;
a priority calculator that calculates a priority of the work for the lavatory equipment determined to require the work based on the acquired information; and
an output unit that outputs the calculated priority.

2. The management apparatus of claim 1, further comprising:
a generator that generates display information for displaying a set of the lavatory equipment determined to require the work and the priority, based on the calculated priority, wherein
the output unit outputs the priority by outputting the display information to an external terminal device used by a person in charge of the work on the lavatory equipment.

3. The management apparatus of claim 2, wherein
the display information is configured to display the set side by side in descending order of priority.

4. The management apparatus of claim 1, wherein
the priority of the lavatory equipment determined to require work of at least one of the replenishment of the consumable and the removal of the abnormality is higher than the priority of the lavatory equipment determined to require the cleaning work.

5. The management apparatus of claim 4, wherein
the priority of the lavatory equipment determined to require the work of removing the abnormality is higher than the priority of the lavatory equipment determined to require the work of replenishing the consumable.

6. The management apparatus of claim 1, further comprising:
a work order determination unit that determines a work order of the lavatory equipment determined to require the work based on the priority output from the output unit; and
a generator that generates display information for displaying a set of the lavatory equipment determined to require the work and the work order based on the work order, wherein
the output unit outputs the display information to an external terminal device used by a person in charge of the work on the lavatory equipment.

7. The management apparatus of claim 6, wherein
the work order determination unit determines the work order based on the priority and at least one of a movement distance, a movement time, presence or absence of floor movement, a number of floor movements, and means for floor movement when movement is performed from a current position of the person in charge to the lavatory equipment determined to require the work, an elapsed time after the lavatory equipment is determined to require the work, and a dirt degree, a number of times of use, and a use state of the lavatory equipment determined to require the work.

8. The management apparatus of claim 1, wherein the lavatory equipment includes a toilet, a urinal, and a washbasin,
wherein the priority calculator calculates the priority based on a comparison between a use degree of the lavatory equipment calculated based on the acquired information and a predetermined threshold value, and
wherein the threshold value includes a threshold value for the toilet, a threshold value for the urinal, and a threshold value for the washbasin which are different each other.

9. The management apparatus of claim 1, wherein
the priority calculator calculates the priority based on a necessity of work on an installation disposed outside the lavatory space in a facility in which the lavatory space is provided.

10. The management apparatus of claim 1, wherein
the priority calculator calculates the priority based on at least one of a movement distance, a movement time, presence or absence of floor movement, a number of floor movements, and means for floor movement when movement is performed from a current position of a person in charge of the work to the lavatory equipment determined to require the work, an elapsed time after the lavatory equipment is determined to require the work, and a dirt degree, a number of times of use, and a use state of the lavatory equipment determined to require the work.

11. The management apparatus of claim 2, wherein
upon receiving an input indicating that the work is suspended for specific lavatory equipment among pieces of the lavatory equipment determined to require the work from the terminal device, the generator generates the display information in which the set related to the specific lavatory equipment is deleted.

12. The management apparatus of claim 11, wherein
the generator generates the display information to re-display the deleted set, when a predetermined re-display condition is satisfied.

13. The management apparatus of claim 2, wherein
the generator generates the display information to automatically transmit a message that the work on the lavatory equipment determined to require the work has been completed, to the management apparatus when a predetermined work completion condition is satisfied.

14. A non-transitory computer-readable storage medium storing a management program causing a computer to function as:
an information acquirer that acquires information from at least one of lavatory equipment and a sensor installed in a lavatory space;
a work necessity determination unit that determines, based on the acquired information, the lavatory equipment that requires work including cleaning and at least one of replenishment of a consumable and removal of an abnormality;
a priority calculator that calculates a priority of the work for the lavatory equipment determined to require the work based on the acquired information; and
an output unit that outputs the calculated priority.

15. A management system comprising:
a terminal device that is used by a person in charge of work on lavatory equipment installed in a lavatory space; and
a management apparatus that manages the work on the lavatory equipment, wherein
the management apparatus includes
an information acquirer that acquires information from at least one of the lavatory equipment and a sensor installed in the lavatory space,
a work necessity determination unit that determines, based on the acquired information, the lavatory equipment that requires work including cleaning and at least one of replenishment of a consumable and removal of an abnormality,
a priority calculator that calculates a priority of the work on the lavatory equipment determined to require the work based on the acquired information,
a generator that generates display information for displaying a set of the lavatory equipment determined to require the work and the priority based on the calculated priority, and
an output unit that outputs the generated display information to the terminal device, and
wherein the terminal device includes a presenter that presents the display information output from the management apparatus, to the person in charge.

16. A terminal device comprising:
a presenter that presents, to a person in charge of work, a priority output from a management apparatus that calculates the priority of work on lavatory equipment that requires the work including cleaning and at least one of replenishment of a consumable and removal of an abnormality, based on information acquired from at least one of the lavatory equipment and a sensor installed in a lavatory space.

17. A non-transitory computer-readable storage medium storing a management program causing a computer to function as:
a presenter that presents, to a person in charge of work, a priority output from a management apparatus that calculates the priority of work on lavatory equipment that requires the work including cleaning and at least one of replenishment of a consumable and removal of an abnormality, based on information acquired from at least one of the lavatory equipment and a sensor installed in a lavatory space.
